(19) United States
(12) Patent Application Publication
(10) Pub. No.: US 2010/0253800 A1
(43) Pub. Date: Oct. 7, 2010

(54) FOCUSING APPARATUS USING A PLASTIC LEAD SCREW

(75) Inventors: Kota MIYA, Saitama (JP); Kouhei OGUMA, Tokyo (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/749,609

(22) Filed: Mar. 30, 2010

(30) Foreign Application Priority Data
Apr. 3, 2009 (JP) 2009-090932

(51) Int. Cl. G02B 7/09; H04N 5/228; G03B 13/36

(52) U.S. Cl. 348/222.1; 359/811; 348/E05.031; 348/E05.045

(57) ABSTRACT

A focusing apparatus having a lead screw made of resin, both ends of which are supported by at least one stationary member to be freely rotatable, and a focusing lens group that is movable in an optical axis direction by rotation of the lead screw, the focusing apparatus includes a position detection sensor for detecting whether the focusing lens group is positioned at a reference position in the optical axis direction, and a focus detector which performs a focus-state detecting operation to detect a focus state of an object. The focusing apparatus moves the focusing lens group to a predetermined lens position in which the focus-state detecting operation is not performed, and the reference position is positioned in a close vicinity of the predetermined lens position.

### BACKGROUND OF THE INVENTION

1. Field of the Invention

The present invention relates to a focusing apparatus which uses a plastic lead screw to drive a focusing optical system.

2. Description of the Prior Art

In compact digital cameras, a mechanism which uses a lead screw to drive a focusing lens group, provided as a focusing optical system, in an optical axis direction is known in the art.

The lead screw is driven to rotate by a motor. For transmission of rotation of the output shaft of the motor to the lead screw, a pinion is fitted on the output shaft of the motor, a spur gear is fitted on the lead screw, and the pinion and the spur gear are connected to each other via a reduction gear train. A nut is screw-engaged with the lead screw, this nut is coupled to a focusing lens group frame, and forward and reverse movements of the nut that are caused by forward and reverse rotations of the lead screw cause the focusing lens group frame to move forwardly and reversely, respectively. It is desirable that the thermal expansion coefficient of the lead screw be small because the dimensional accuracy of the lead screw must be high to drive the focusing lens group with precision. Accordingly, a metallic material is conventionally used as the material of the lead screw.

Since it is costly to make the lead screw out of a metallic material, an invention to make the lead screw out of a synthetic resin has been proposed in Japanese Unexamined Patent Publication H09-215308.

However, synthetic resin has a higher expansion coefficient than metal, so that the length of the lead screw made of synthetic resin varies widely due to variations of the ambient temperature.

In addition, the position of the focusing lens group in the moving range in the optical axis direction thereof, in which no positional adjustment in the optical axis direction of the focusing lens group is carried out by a focus detection method such as a contrast detection method, is conventionally determined by the number of rotations of a lead screw based on the lead thereof. Accordingly, in the case of moving the focusing lens group to a specific position (e.g., infinity focus position) in which no positional adjustment is made to the focusing lens group in the optical axis direction by a focus detection method, the specific position of the focusing lens group in the aforementioned moving range is determined by the number of rotations of the lead screw, i.e., the number of driving steps for driving a stepping motor, from the initial position of the focusing lens group. However, in the case of a plastic lead screw, if the position of the focusing lens group is controlled by the number of rotations of the lead screw, the length thereof varies widely due to variations in temperature, and accordingly, a problem occurs with the moving amount of the focusing lens group fluctuating greatly due to variations in temperature, i.e., the stop position of the focusing lens group fluctuates greatly due to variations in temperature. For instance, in the case of using a plastic lead screw to drive a focusing lens group in a camera which sets the focusing lens group at an infinity focus position in an infinity mode, the focusing lens group deviates from the infinity focus position in the exposure mode if the temperature varies from a reference temperature (approximately 25 degrees centigrade). Specifically, under the condition in which the depth of field is narrow, e.g., in the case of a long focal length, such a positional deviation of the focusing lens group causes the image to appear blurred conspicuously.

### SUMMARY OF THE INVENTION

The present invention that has been devised in view of the above noted problems that reside in the prior art, and provides a focusing apparatus using a plastic lead screw which moves a focusing lens group by rotation of the lead screw, and which is capable of minimizing the positional deviation of the focusing lens group caused by temperature variations even if the lead screw is made of resin.

According to an aspect of the present invention, a focusing apparatus is provided, including a lead screw made of resin, both ends of which are supported by at least one stationary member to be freely rotatable, and a focusing lens group that is movable in an optical axis direction by rotation of the lead screw, the focusing apparatus including a position detection sensor for detecting whether the focusing lens group is positioned at a reference position in the optical axis direction, and a focus detector which performs a focus-state detecting operation to detect a focus state of an object. The focusing apparatus moves the focusing lens group to a predetermined lens position in which the focus-state detecting operation is not performed, and the reference position is positioned in a close vicinity of the predetermined lens position.

It is desirable for the focusing apparatus to be incorporated in a digital camera, and for the focus detector to include an image sensor and detect the focus state of the object by detecting contrasts of object images which are captured via the image sensor while the focusing apparatus moves the focusing lens group stepwise by rotating the lead screw stepwise.

It is desirable for the focusing apparatus to include a memory which stores a rotation amount of the lead screw as a set value required to move the focusing lens group to the predetermined lens position from a moment the point detection sensor detects that the focusing lens group is positioned at the reference position.

It is desirable for the focusing apparatus to include a driver which rotates the lead screw, a measuring apparatus which measures a rotation amount of the lead screw from a moment the position detection sensor detects that the focusing lens group is positioned at the reference position, and a controller which controls rotation of the lead screw via the driver based on the set value that is stored in the memory and the rotation amount that is measured by the measuring apparatus when the controller moves the focusing lens group to the predetermined lens position.

It is desirable for the measuring apparatus to continue to measure a position of the focusing lens group in the optical axis direction as the rotation amount of the lead screw from when the position detection sensor detects that the focusing lens group is positioned at the reference position. When the focusing apparatus moves the focusing lens group to the predetermined lens position, the controller controls the driver so that a measurement value measured by the measuring apparatus becomes equal to the set value stored in the memory.

When moving the focusing lens group to the predetermined lens position, it is desirable for the controller to drive the driver in a direction to allow the position detection sensor to detect the focusing lens group when the focusing lens group is positioned at the reference position, wherein the controller actuates the driver in a direction to move the focusing lens group to the predetermined lens position and makes the measuring apparatus commence measuring the rotation amount of the lead screw from a moment the point detection sensor detects that the focusing lens group is positioned at the reference position, and the controller stops driving the driver upon a measurement value measured by the measuring apparatus becoming equal to the set value that is stored in the memory.

The predetermined lens position can correspond to an infinity focus position.

It is desirable for the focusing lens group to be continuously biased toward a short distance side by a resilient member, and for the predetermined lens position and the position detection sensor to be positioned in a close vicinity of a rear limit of a moving range of the focusing lens group which is determined by the lead screw.

It is desirable for a gear to be formed integrally with the lead screw, and for the lead screw to be rotated by a motor.

It is desirable for the measuring apparatus to measure a number of rotations of the lead screw as a number of rotations of the motor or a number of rotations of said gear.

It is desirable for the position detection sensor to be a photo interrupter.

According to the present invention, the predetermined lens position can be prevented from deviating from the original position thereof even if the focusing apparatus adopts a plastic lead screw because a position detection sensor for detecting the position of the focusing lens group is positioned in the vicinity of the predetermined lens position that is set at a position where a focus state achieved by the focusing lens group is not detected.

By forming a gear integrally on the lead screw, the effective length of the lead-threaded portion (threaded portion) of the lead screw can be made longer, and a reduction in the number of elements of the focusing apparatus and miniaturization thereof can be achieved.

The present disclosure relates to subject matter contained in Japanese Patent Application No. 2009-90932 (filed on Apr. 3, 2009) which is expressly incorporated herein by reference in its entirety.

### BRIEF DESCRIPTION OF THE DRAWINGS

The present invention will be discussed below in detail with reference to the accompanying drawings, in which:

FIG. 1A is a longitudinal sectional view of a main part of a focusing mechanism of a digital camera equipped with a focusing apparatus using a plastic lead screw according to the present invention when the focusing lens group is positioned at a focus origin position;

FIG. 1B shows a partial viewed in the direction of the arrow “a” shown in FIG. 1A, showing a portion of the focusing apparatus which includes a position detection sensor;

FIG. 2 is a longitudinal sectional view of the main part of the focusing mechanism shown in FIG. 1 when the focusing lens group is positioned at the infinity focus position that is closer to the object side than the focus origin position;

FIG. 3 is a perspective view of the plastic lead screw, with which a spur gear is formed integrally;

FIG. 4 is an explanatory drawing illustrating a state where the focusing lens group is continuously biased toward the short-distance focus position in the focusing apparatus;

FIGS. 5A and 5B are explanatory diagrams illustrating different states of the lead screw of the focusing apparatus, wherein FIG. 5A shows a state of the lead screw at a reference ambient temperature when the focusing lens group is positioned at the infinity focus position, and FIG. 5B shows a state of the lead screw when the temperature has risen from the reference ambient temperature from the state shown in FIG. 5A;

FIGS. 6A and 6B are explanatory diagrams illustrating influences caused by the thermal expansion of the lead screw when the focusing lens group is moved from the focus origin position to the infinity focus position by controlling the number of rotations of the lead screw with the focus origin being set on the short distance side, wherein FIG. 6A shows a state where the focusing lens group has been moved from the focus origin position to the infinity focus position by rotating the lead screw through a predetermined amount of rotation at the reference ambient temperature, and FIG. 6B shows a state where the focusing lens group has been moved from the focus origin by rotating the lead screw through the same predetermined amount of rotation at a temperature higher than the reference ambient temperature;

FIGS. 7A and 7B are explanatory diagrams illustrating influences caused by the thermal expansion of the lead screw when the focusing lens group is moved from the focus origin position to the infinity focus position by controlling the number of rotations of the lead screw with the focus origin position being set in the vicinity of the infinity focus position, wherein FIG. 7A shows a state where the focusing lens group has been moved from the focus origin position to the infinity focus position by rotating the lead screw through a predetermined amount of rotation at the reference ambient temperature, and FIG. 7B shows a state where the focusing lens group has been moved from the focus origin position by rotating the lead screw through the same predetermined amount of rotation at a temperature higher than the reference ambient temperature;

FIG. 8 is a block circuit diagram showing main circuit elements of the digital camera; and

FIG. 9 is a flow chart showing a process of moving the focusing lens group to the infinity focus position in infinite mode.

### DESCRIPTION OF THE PREFERRED EMBODIMENTS

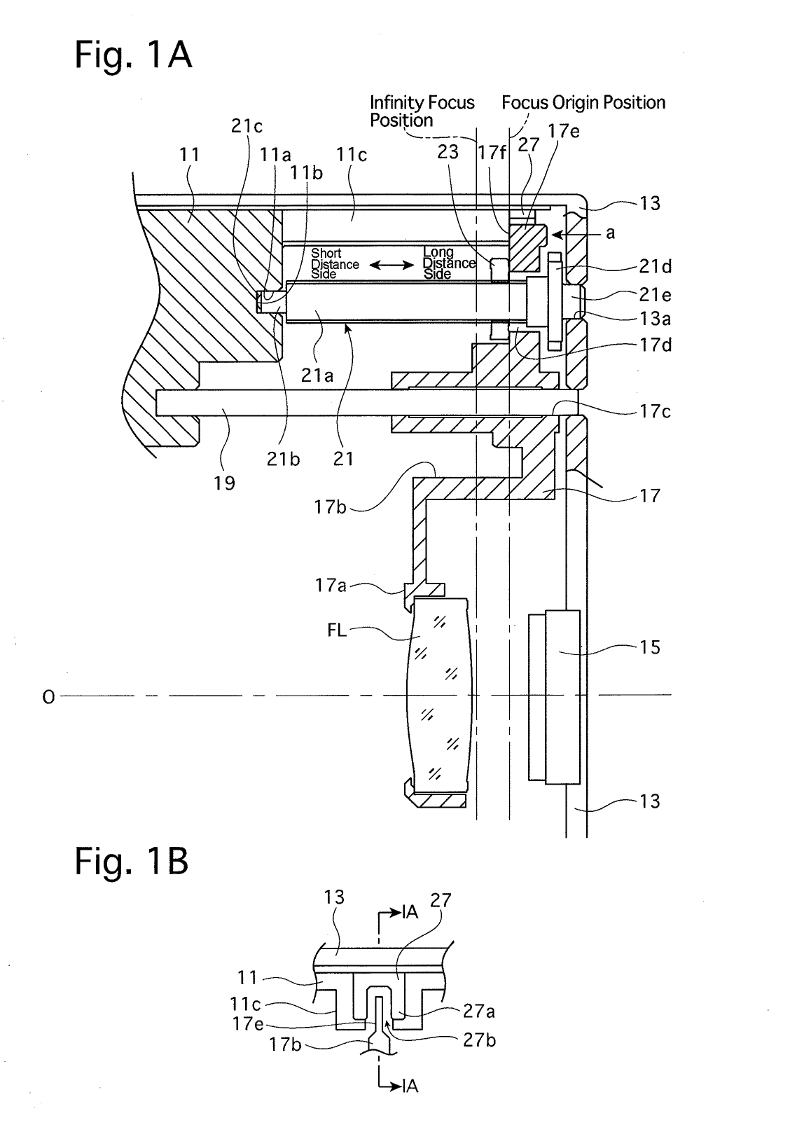

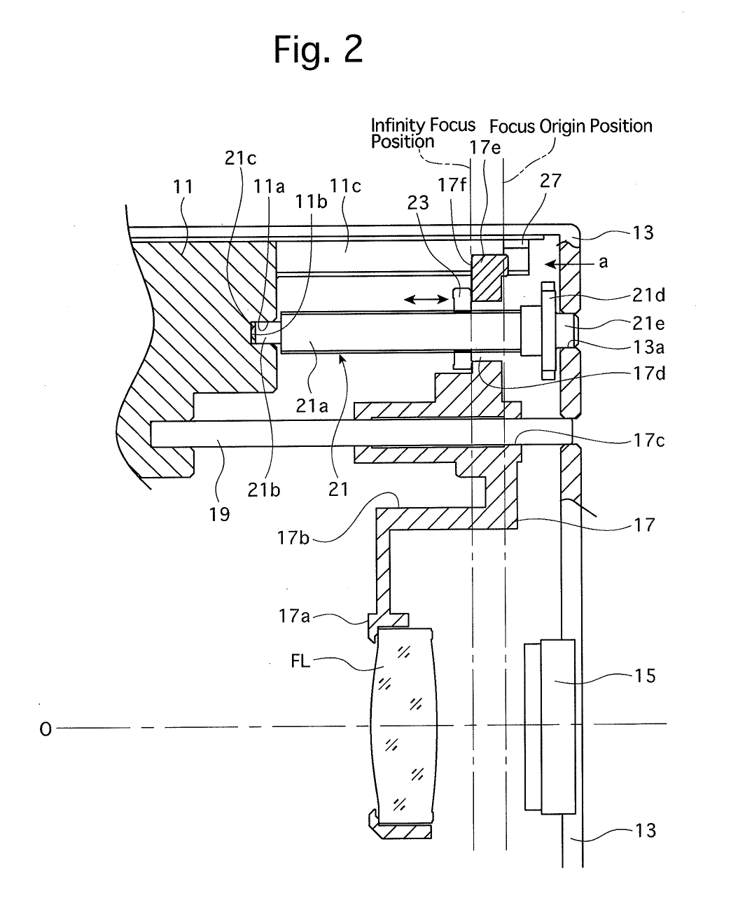

FIGS. 1A and 2 each show a longitudinal sectional view of a main part of a focusing mechanism of a compact digital camera equipped with a focusing apparatus using a plastic lead screw according to the present invention, and FIG. 1B is a diagram viewed in the direction of the arrow “a” shown in FIG. 1A, showing part of the focusing apparatus which includes a position detection sensor.

This compact digital camera is provided with a housing 11 fixed to a camera body (not shown), and an image sensor holder 13 f fixed to the housing 11. An image sensor (image pickup device) 15 is mounted to the image sensor holder 13.

The focusing mechanism is provided with a linear guide shaft 19 and a lead screw 21. The lead screw 21 is made of a synthetic resin. The digital camera is provided with a focusing lens group frame 17 which holds a focusing lens group FL, and the linear guide shaft 19 supports the focusing lens group frame 17 so that the focusing lens group frame 17 can move freely along an optical axis O of a photographing optical system provided in the digital camera that includes the focusing lens group FL. Both ends of the linear guide shaft 19 are supported by the housing 11 and the image sensor holder 13, respectively, and both ends of the lead screw 21 are also supported by the housing 11 and the image sensor holder 13, respectively. The linear guide shaft 19 and the lead screw 21 are supported by the housing 11 and the image sensor holder 13 to extend parallel to the optical axis O.

The focusing lens group frame 17 is provided with a lens holding frame 17a in which the focusing lens group FL is fitted to be held thereby. A guide arm 17b which extends integrally from the lens holding frame 17a is provided with a guide shaft insertion hole 17c, a lead-shaft insertion hole 17d and a light shield plate 17e. The linear guide shaft 19 is fitted into the guide shaft insertion hole 17c so that the focusing lens group frame 17 is freely slidable on the linear guide shaft 19. The lead screw 21 is inserted into the lead-shaft insertion hole 17d without being in contact with the inner peripheral surface of the lead-shaft insertion hole 17d. The light shield plate 17e for detecting the position of the focusing lens group FL is formed integrally with the guide arm 17b.

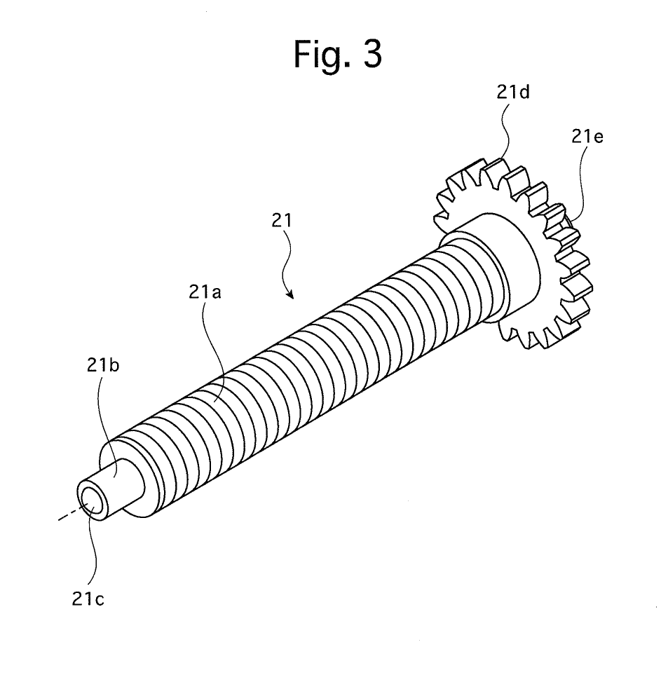

As shown in FIG. 3, that shows a perspective view of the lead screw 21, the lead screw 21 is provided at the front end of a lead-threaded portion (threaded portion) 21a thereof with a small-diameter front shaft portion 21b, and the front shaft portion 21b is provided at the front end thereof with a semispherical portion 21c serving as a bearing. The lead-threaded portion 21a is provided at the rear end thereof with a spur gear 21d, and the lead screw 21 is provided at the rear end thereof with a rear shaft portion 21e which projects rearward from the center of the spur gear 21d. The lead screw 21 is molded of a synthetic resin such as an engineering plastic (namely, polyacetal resin) by injection molding so that all the above noted elements 21a through 21d of the lead screw 21 are integrally formed.

The semispherical portion 21c and the front shaft portion 21b of the lead screw 21 are inserted into a lead-shaft bearing hole 11a formed in the housing 11 with the semispherical portion 21c being in contact with the base 11b of the bearing hole 11a, and the rear shaft portion 21e is inserted into a lead-shaft bearing hole 13a formed in the image sensor holder 13. The lead-threaded portion 21a of the lead screw 21 is inserted into the lead-shaft insertion hole 17d of the guide arm 17b, and thereafter an AF nut 23 is screw-engaged with the lead-threaded portion 21a. The AF nut 23 is provided with a radial projection (not shown) which is engaged in an axial groove (not shown) which is formed on the housing 11 to extend parallel to the optical axis O. Due to this engagement of the radial projection of the AF nut 23 with the axial groove of the housing 11, the AF nut 23 moves forward/rearward without rotating relative to the housing 11.

It is desirable that the AF nut 23 be made of the same material as the lead screw 21, e.g., a polyacetal resin.

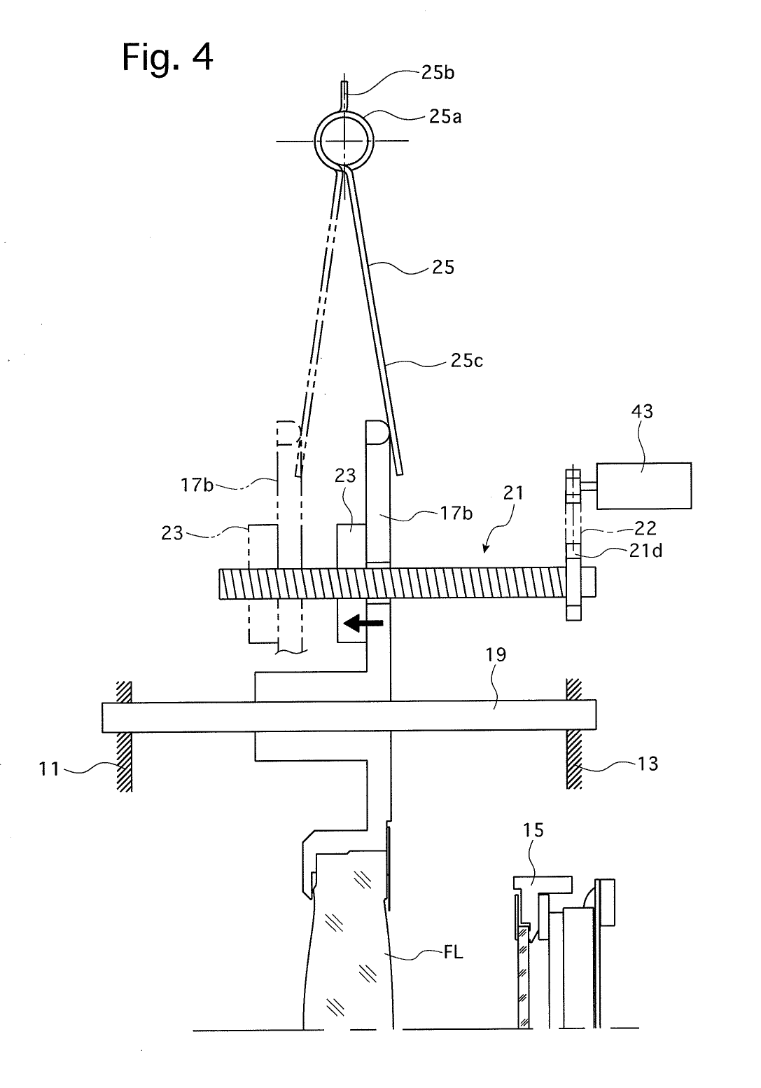

As shown in FIG. 4, the guide arm 17b is resiliently biased in the forward direction (leftward with respect to FIG. 4) by a torsion spring 25 so as to remain in contact with the AF nut 23 from behind. Due to this biasing force of the torsion spring 25, the position of the guide arm 17b in the optical axis direction is restricted by the AF nut 23 at all times, and accordingly, the guide arm 17b moves forward/rearward with the position thereof being restricted by movements of the AF nut 23 in the optical axis direction. The torsion spring 25 is provided with a coiled portion 25a, a short arm 25b and a long arm 25c. Each of the short arm 25b and the long arm 25c extends radially outwards from the coiled portion 25a. The coiled portion 25a is fitted on a shaft (not shown) which either projects from or is fixed to the housing 11, the short arm 25b is engaged with the housing 11, and the long arm 25c is engaged with the guide arm 17b. In addition, the coiled portion 25a resiliently twists the torsion spring 25 in a manner such that the long arm 25c biases the guide arm 17b in the leftward direction with respect to FIG. 1.

Since the lead screw 21 is biased forward by the torsion spring 25 via the guide arm 17b and the AF nut 23, the semispherical portion 21c, which is provided at the front end of the front shaft portion 21b, is continuously pressed against the base 11b of the bearing hole 11a. Accordingly, the lead screw 21 thermally expands and contracts relative to the base 11b.

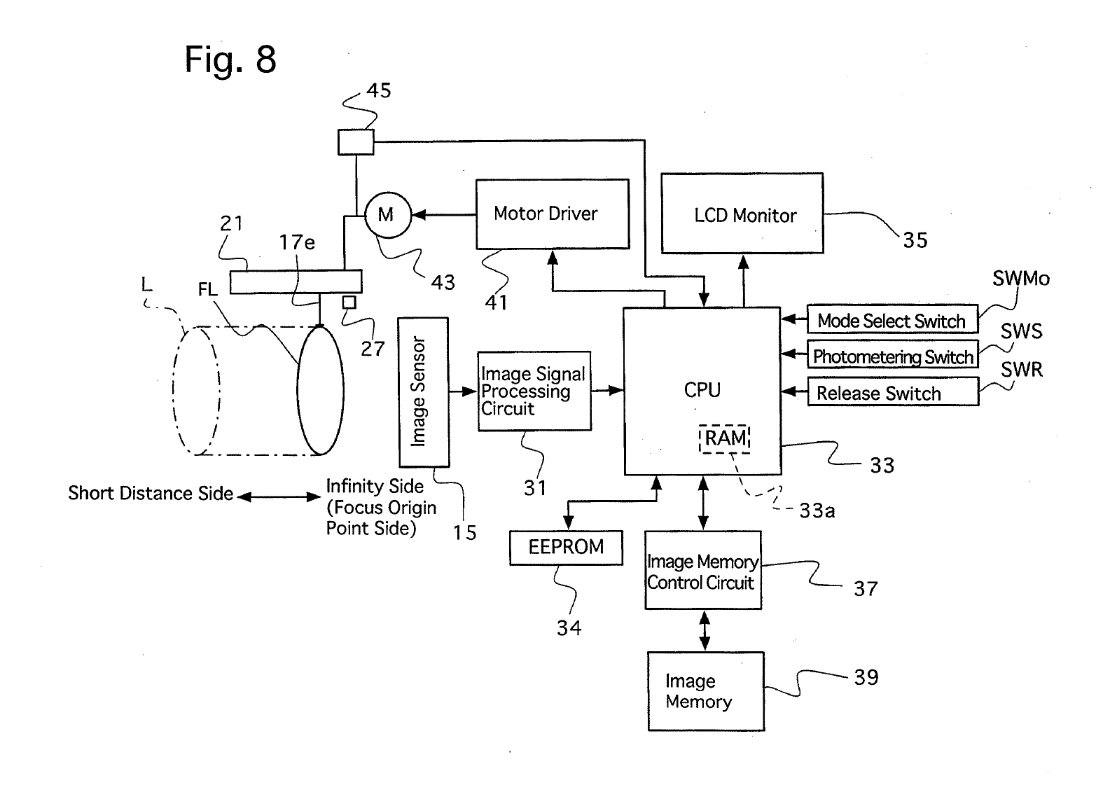

The spur gear 21d of the lead screw 21 is engaged with a reduction gear train 22 driven by an AF motor (driver) 43 (see FIGS. 4 and 8). A rotation of the AF motor 43 causes the lead screw 21 to rotate at a rotation speed reduced by the reduction gear train. Thereupon, the AF nut 23, which is screw-engaged with the lead-threaded portion 21a, moves forward/rearward in accordance with the lead thread of the lead-threaded portion 21a when the lead screw 21 is rotated. The moving amount of the AF nut 23 in a direction parallel to the optical axis O and the position of the AF nut 23 in the same direction are determined by the lead of the lead-threaded portion 21a and the amount of rotation of the lead screw 21. This amount of rotation of the lead screw 21 is measured by counting AF pulses output from an encoder (measuring apparatus) 45 (see FIG. 8) which operates in association with the rotation of the lead screw 21. If a stepping motor is used as the AF motor 43, the amount of rotation of the lead screw 21 and the position of the AF nut 23 can be measured by counting the number of driving steps for driving the stepping motor.

The focusing mechanism provided in the present embodiment of the digital camera is configured so that the photographing distance becomes shorter as the focusing lens group FL is positioned closer to the front, and the photographing distance becomes longer as the focusing lens group FL is positioned closer to the rear. In the present embodiment, the infinity focus position (in-focus position for an object at an infinite distance) of the focusing lens group FL is determined with the position of an origin detection sensor 27 being taken as a reference position. In the present embodiment, the position of the focusing lens group FL is detected at all times by counting AF pulses from the reference position. A focus state of the target object is detected by a contrast detection method. In the AF process according to this contrast detection method, images are captured consecutively while the focusing lens group FL is moved stepwise in a given direction, and contrasts (contrast values) of the captured images (focus states thereof) are detected. Thereafter, a peak contrast value (peak contrast) is detected from the detected contrasts to obtain the position of the focusing lens group L1 at which this peak contrast value is obtained, i.e., an in-focus lens position of the focusing lens group L1 is obtained. Thereupon, the focusing lens group FL is moved to the in-focus lens position thus obtained.

Note that in the embodiment shown in FIGS. 1A, 2, 4, 5A, 5B, 7A and 7B, the short distance side is on the object side (left side) and long distance side is on the image side (right side).

The origin detection sensor 27 is a transmission photo interrupter equipped with a light emitting element and a light receiving element which receives light emitted from the light emitting element. As shown in FIG. 1B, the origin detection sensor 27 is provided with a U-shaped housing 27a having a gap 27b, and the light emitting element and the light receiving element are fixed to opposed surfaces of the housing 27a in the gap 27b. The origin detection sensor 27 is configured to allow the light shield plate 17e to pass through the gap 27b to be capable of detecting whether or not the light emitted from the light emitting element toward the light receiving element is interrupted by the light shield plate 17e.

The origin detection sensor 27 in the present embodiment of the digital camera is configured to be turned ON when the gap 27b is exposed (i.e., not interrupted by the light shield plate 17e) and OFF when the light emitted from the light emitting element toward the light receiving element is interrupted by the light shield plate 17e, respectively. The origin detection sensor 27 detects the front edge 17f when the light shield plate 17e moves forward from a rearward position, to which the light shield plate 17e has first moved rearward upon passing through the gap 27b. The position at which the origin detection sensor 27 detects the front edge 17f defines the focus origin position of the light shield plate 17e.

FIG. 1A shows a state where the focusing lens group FL is positioned at the focus origin position and FIG. 2 shows a state where the focusing lens group FL is positioned at an infinity focus position (in-focus position for an object at an infinite distance) that is positioned at a predetermined number of AF pulses forwardly (toward the object side) away from the focus origin position.

In the present embodiment, the housing 11 is provided with a sensor mounting groove 11c having a U-shaped cross section which extends parallel to the optical axis O. The origin detection sensor 27 is inserted into the sensor mounting groove 11c from the image sensor holder 13 side and then fixed after the position of the origin detection sensor 27 in the optical axis direction is determined.

It is desirable that the origin detection sensor 27 be fixed precisely at a detection position for the detection of the infinity focus position of the focusing lens group FL. However, it is sometimes the case that the origin detection sensor 27 is fixed at a position slightly deviating forwardly or rearwardly from the detection position of the infinity focus position (specifically within ±100 pulses (±0.5 mm)). In the present embodiment, it is assumed that the fixed position of the origin detection sensor 27 slightly deviates (rearwardly) from the detection position.

The infinity focus position is set during a manufacturing process of the digital camera in a manner which will be discussed hereinafter. First, the AF motor 43 is actuated to move the focusing lens group FL toward the infinity focus position from the short distance side. Thereafter, the origin detection sensor 27 is turned OFF from the ON state upon detecting the light shield plate 17e (i.e., upon the light shield plate 17e interrupting the light emitted between the gap 27b). Subsequently, upon the origin detection sensor 27 being turned ON from the OFF state (upon the light shield plate 17e passing through the gap 27b), the AF motor 43 is actuated in the reverse direction to move the focusing lens group FL toward the short distance side. Thereupon, an AF pulse counting operation commences from the moment the origin detection sensor 27 is turned OFF from the ON state, which is determined as the focus origin position, and another measuring apparatus determines whether or not an object at an infinite distance has been brought into focus, so that the position of the focusing lens group FL at which the object at an infinite distance is in an in-focus state is determined as the infinity focus position. The number of AF pulses required to drive the focusing lens group FL from the focus origin position to the infinity focus position is set as an infinity value N (set value), and this infinity value N is stored in memory, e.g., in an EEPROM 34 (see FIG. 8).

The infinity value N is utilized from thereafter for controlling the movement of the focusing lens group FL to the infinity focus position when the digital camera of the present embodiment is in use. When the focusing lens group FL moves to the infinity focus position (referred to as an infinity mode hereinafter), the driving of the AF motor 43 is controlled so that the light shield plate 17e passes through the gap 27b of the origin detection sensor 27 toward the short distance side until the front edge 17f of the light shield plate 17e coincides with the focus origin position (so that the origin detection sensor 27 changes from the ON state to the OFF state) thereby detecting the focus origin position, and thereafter, the AF motor 43 is driven (using the focus origin position as a reference position) by an amount corresponding to the infinity value N stored in the EEPROM 34 to advance the focusing lens group FL to the infinity focus position.

Immediately after the power of the camera is turned ON, the focus origin position is obtained by controlling the driving of the AF motor 43 so that the light shield plate 17e passes through the gap 27b of the origin detection sensor 27 in the direction toward the short distance side from the long distance side (i.e., so that the origin detection sensor 27 changes from the ON state to the OFF state). Thereafter, while the power is ON (until being turned OFF), the number of AF pulses that are output from the encoder 45 continues to be counted from the focus origin position. Therefore, the focusing lens group FL can be advanced to the infinity focus position even if the driving of the AF motor 43 is not controlled so as to make the light shield plate 17e pass through the gap 27b of the origin detection sensor 27 in the infinity mode (predetermined photographing mode). However, because there is a possibility of error accumulating if the driving of the AF motor 43 is controlled in accordance only with the number of AF pulses, when the focusing lens group FL is moved to the infinity focus position during the infinity mode, the focusing lens group FL is first moved back to the focus origin position before moving to the infinity focus position.

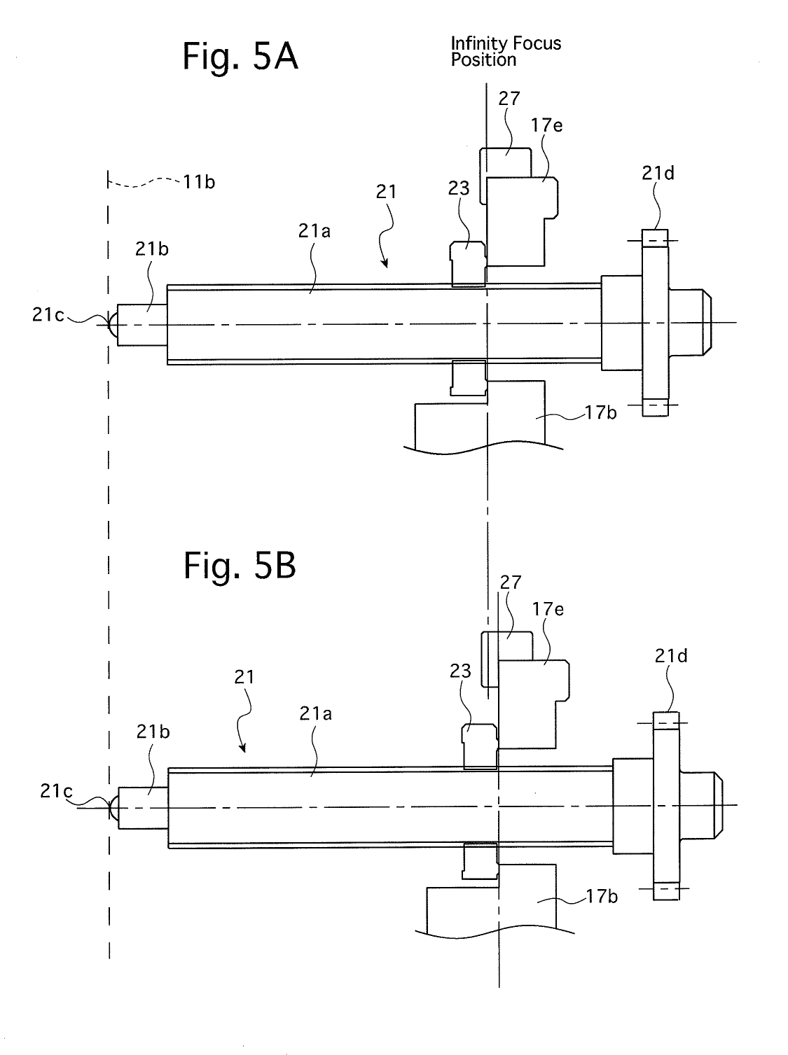

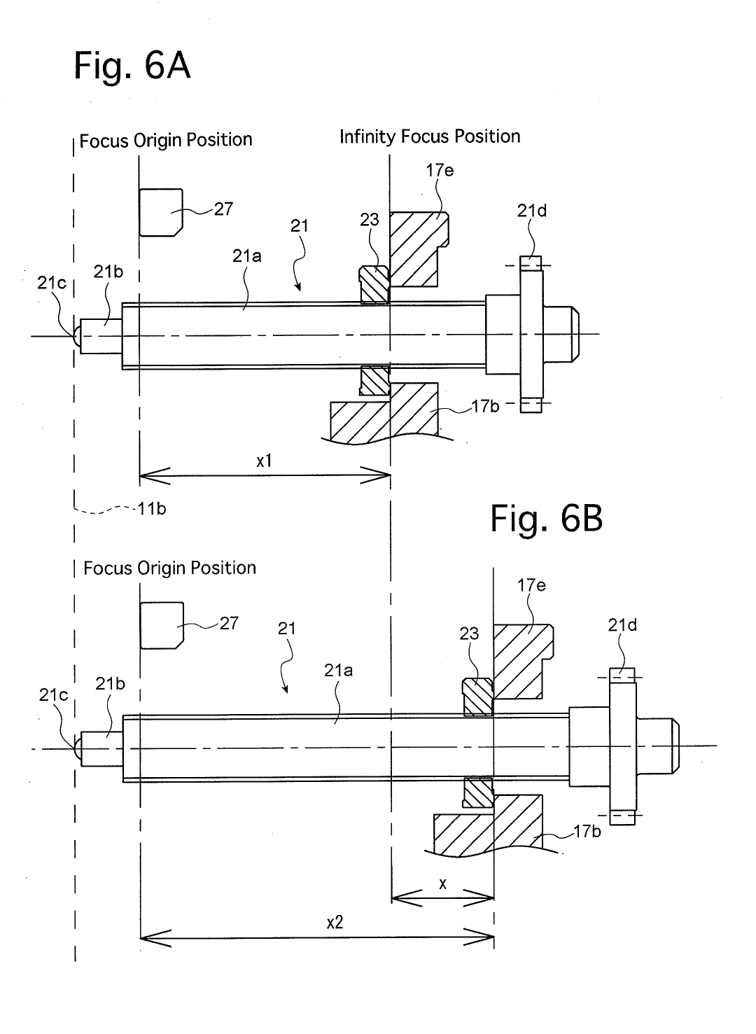

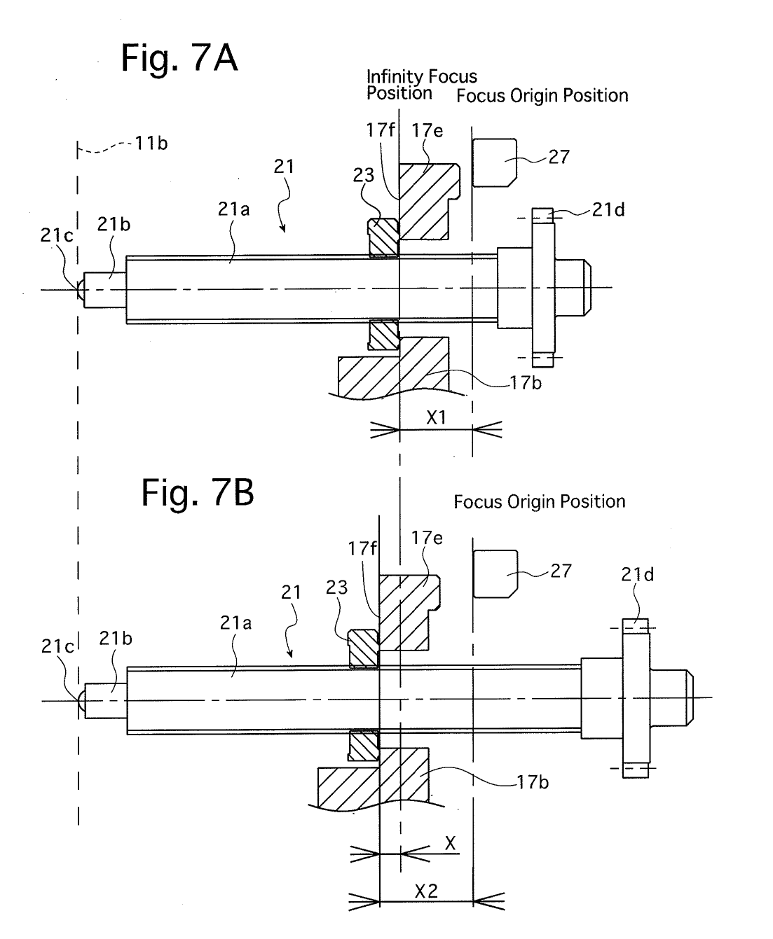

FIGS. 5A, 5B, 6A, 6B, 7A and 7B show different states of the lead screw 21 according to temperature variations. FIGS. 5A, 6A and 7A each show a state where the focusing lens group FL has been moved from the focus origin position to the infinity focus position by rotating the lead screw 21 at a reference ambient temperature (approximately 25 degrees centigrade). FIG. 5B shows a state where the ambient temperature has risen from the state shown in FIG. 5A. FIGS. 6B and 7B each show a state where the focusing lens group FL has been moved to the focus origin position by rotating the lead screw 21 by the same amount of rotation as that in the case shown in FIGS. 6A and 7A, respectively, in a state (high temperature state) where the ambient temperature has risen from the reference ambient temperature.

The lead screw 21 is in pressing contact at the semispherical portion 21c thereof with the base 11b of the bearing hole 11a since the guide arm 17b of the focusing lens group frame 17 is continuously biased forward by the torsion spring 25. Therefore, the lead screw 21 expands and contracts with changes in temperature with the base 11b as a reference position. FIG. 5A shows a state where the focusing lens group FL has been moved to the infinity focus position at the reference ambient temperature. From this state shown in FIG. 5A, a rise in ambient temperature causes the lead screw 21 to expand, thus causing the length of the lead screw 21 to increase. FIG. 5B shows a state where the ambient temperature has risen to the maximum temperature in the operating temperature range. If the ambient temperature rises in this manner, the lead screw 21 elongates, which causes the focusing lens group FL to shift toward the image surface from the infinity focus position. Conversely, if the ambient temperature drops, the lead screw 21 contracts, which shifts the focusing lens group FL toward the object side from the infinity focus position.

The amount of expansion/contraction of the housing 11 in the forward/rearward direction along the optical axis O due to temperature variations is far smaller than that of the lead screw 21 and thus practically negligible.

In a contrast AF process in which images are captured consecutively at actual focusing lens positions (actual positions of the focusing lens group) to detect the contrast of an object image, expansion and contraction of the lead screw 21 do not cause a problem. This is because the position of the focusing lens group is controlled by detecting the contrast of an object, not controlled in accordance with the number of pulses for driving the AF motor, so that the lead screw 21 does not influence the object contrast even if the lead screw 21 expands or contracts. However, in the case of controlling the position of the focusing lens group in accordance with the number of AF pulses from the focus origin position, for instance, when the focusing lens group FL is moved to a predetermined lens position, an error in the position of the focusing lens group FL increases in the moving range thereof on the long distance side that is positioned away from the base 11b of the bearing hole 11a if the position of the focusing lens group FL is controlled by the amount of rotation of the lead screw 21, specifically controlled with reference to a position on the base 11b side. Namely, if the focus origin position is set on the short distance side, the number of rotations of the lead screw 21 necessary to move the focusing lens group FL from the focus origin position to the infinity focus position is great, and accordingly, an error in the position of the focusing lens group FL which is caused when the focusing lens group FL is moved to the infinity focus position by controlling the number of rotations of the lead screw 21 becomes great.

The influence of thermal expansion on the lead screw 21 will be hereinafter discussed with reference to FIGS. 6A, 6B, 7A and 7B. FIGS. 6A and 6B show a comparative example in which the focus origin position is set in the vicinity of the short distance side, namely, the origin detection sensor 27 is fixed in the vicinity of the short distance side at a position away from the infinity focus position, and FIGS. 7A and 7B show an embodiment in which the focus origin position is set in the vicinity of the infinity focus position, specifically the origin detection sensor 27 is fixed far behind the infinity focus position (at a position closer to the image side than the position of the infinity focus position). It should be noted that the degree of expansion/contraction of the lead screw 21 is exaggerated for clarity in the drawings shown in FIGS. 6B and 7B.

In the comparative example shown in FIGS. 6A and 6B, FIG. 6A shows a state where the light shield plate 17e (the focusing lens group FL) is at rest at the infinity focus position at the reference ambient temperature. In this case, the focusing lens group FL has been moved from the focus origin position to the infinity focus position, which is located behind the focus origin position, by rotating the lead screw 21 by a predetermined amount of rotation (predetermined number of AF pulses) stored in memory (the EEPROM 34). The distance of travel of the focusing lens group FL from the focus origin position is shown by a distance x1.

If the ambient temperature rises in the state shown in FIG. 6A, the lead screw 21 elongates.

FIG. 6B shows a state where the focusing lens group FL has been moved toward the infinity focus position from the focus origin position by rotating the lead screw 21 by the same amount of rotation as that in the case shown in FIG. 6A in a state where the ambient temperature has risen to the maximum temperature in the operating temperature range. In this case, the following equation is satisfied:

x=x2−x1,

wherein x2 designates the distance of travel of the focusing lens group FL from the focus origin position, and x designates the deviation of the focusing lens group FL position caused by thermal expansion of the lead screw 21 when the lead screw 21 is rotated by the same amount of rotation.

In the embodiments shown in FIGS. 7A and 7B, FIG. 7A shows a state where the light shield plate 17e (the focusing lens group FL) is at rest at the infinity focus position at the reference ambient temperature. In this case, the focusing lens group FL at the focus origin position that is located behind the infinity focus position has been moved to the infinity focus position by rotating the lead screw 21 through a predetermined amount of rotation stored in memory (the EEPROM 34). In this state, the distance of travel of the focusing lens group FL from the focus origin position is designated by a distance X1.

If the ambient temperature rises in the state shown in FIG. 7A, the lead screw 21 elongates.

FIG. 7B shows a state where the focusing lens group FL has been moved toward the infinity focus position from the focus origin position by rotating the lead screw 21 by the same amount of rotation as that in the case shown in FIG. 7A in a state where the ambient temperature has risen to the maximum temperature in the operating temperature range. In this case, the following equation is satisfied:

X=X2−X1,

wherein X2 designates the distance of travel of the focusing lens group FL from the focus origin position (the position shown in FIG. 7B), and X designates the deviation of the focusing lens group FL position caused by thermal expansion of the lead screw 21 when the lead screw 21 is rotated by the same amount of rotation.

Upon comparing the focus position deviation x in the comparative example shown in FIGS. 6A and 6B with the focus position deviation X in the embodiment shown in FIGS. 7A and 7B, it is obvious that the deviation x is greater than the deviation X (x>X). Namely, it can be understood that the deviation X, which is shorter in distance from the focus origin position than the deviation x and which occurs in the embodiment in which the focus origin position is positioned in the vicinity of the infinity focus position, is smaller than the deviation x.

Additionally, in the present embodiment of the digital camera, the fore-and-aft range of the infinity focus position is considered as a range not used in an image contrast AF process. This is because an object at an infinite distance or a long distance in the vicinity of infinity is small in image contrast variation, which makes it difficult to detect image contrast.

Accordingly, in the present embodiment of the digital camera, the origin detection sensor 27 is positioned in the vicinity of the infinity focus position (see FIGS. 1, 2, 5A and 5B), and the amount of travel of the focusing lens group FL from the moment the origin detection sensor 27 detects the focusing lens group frame 17 until the focusing lens group frame 17 reaches the infinity focus position is determined by the number of rotations of the lead screw 21, specifically the number of AF pulses (the infinity value N) that is output from the encoder 45. According to this structure, the accumulating error caused by thermal expansion of the lead screw 21 and also influence caused thereby can be minimalized because the amount of movement of the focusing lens group FL (the focusing lens group frame 17) from the moment the origin detection sensor 27 detects the position of the focusing lens group FL is small.

A process of measuring the infinity value N and a process of writing this measured infinity value N into the EEPROM 34 are performed at the manufacturing stage of the digital camera.

When the focusing lens group FL is moved to the infinity focus position via an operation by the user of the digital camera, the AF motor 43 is driven by an amount corresponding to the infinity value N written in the EEPROM 34 after the origin detection sensor 27 detects the focus origin position. This drive control process makes it possible to move the focusing lens group FL to the infinity focus position with precision even if the lead screw 21 expands or contracts due to temperature variations.

Since the front end of the lead screw 21 is prevented from moving forward by the base 11b of the bearing hole 11a, the amount of expansion/contraction of the lead screw 21 increases in a direction away from the base 11b. However, in the present embodiment of the digital camera, since the origin detection sensor 27 is positioned in the vicinity of the infinity focus position so that the distance between the infinity focus position and the focus origin position is short, the infinity value N (the number of AF pulses) is small, which reduces the influence of the thermal expansion/contraction of the lead screw.

So long as the origin detection sensor 27 can be structured to be capable of detecting the position of the focusing lens group FL regardless of expansion and contraction of the lead screw 21 at least within the operating temperature range, the origin detection sensor 27 can be a magnetic sensor using a Hall sensor or a different type of sensor utilizing another principle. Although the origin detection sensor 27 can be a contact sensor, it is desirable that the origin detection sensor 27 be a non-contact sensor.

The main configuration of the present embodiment of the digital camera that is equipped with the plastic lead screw 21 will be hereinafter discussed with reference to FIG. 8.

The digital camera is provided with a photographic lens L including the focusing lens group FL, and an image sensor (CCD or CMOS image sensor) 15. An object image formed by the photographic lens L is focused onto a light receiving surface of the image sensor 15. The digital camera 10 is further provided with an image signal processing circuit 31, a CPU (controller) 33, a monitor (LCD) 35, an image memory control circuit 37 and an image memory 39. Each light receiving element (pixel) of the image sensor 15 converts the incident light of an object image thereon into an electrical charge, the image sensor 15 accumulates the electrical charges thus converted and outputs the accumulated charges, pixel by pixel, as an image signal to the image signal processing circuit 31. The image signal processing circuit 31 performs predetermined adjusting processes such as a white-balance adjusting process and an A/D converting process on the input image signal and outputs this image signal as digital image data to the CPU 33. Namely, image data, which has undergone a predetermined process and converted into digital image data in units of pixels in the image signal processing circuit 31, is output to the CPU 33. The CPU 33 converts the image data, which is input to the CPU 33 from the image sensor 15, into an image signal capable of being indicated on the monitor (LCD) 35 to visually indicate the image data as an image on the monitor (LCD) 35 in a through-the-lens mode (monitoring mode). When performing an AF process (contrast AF process), the CPU 33 temporarily stores the input image data in an internal RAM (image cache memory) 33a of the CPU 33 to perform a contrast detection process. In an image recording mode, the CPU 33 performs an image capturing process in which the image sensor 15 is exposed with settings such as an f-number and a shutter speed, and subsequently performs a recording process in which the input image data is converted into image data having a predetermined format to be written into the image memory 39 via the image memory control circuit 37. The EEPROM 34, which serves as a nonvolatile memory and stores various kinds of photographic data, is connected to the CPU 33.

As shown in FIG. 8, the digital camera is provided with a mode select switch SWMo, a photometering switch SWS and a release switch SWR, which are all connected to the CPU 33. In the normal contrast AF process that is performed to detect a focus state of an object, upon the photometering switch SWS being turned ON, the CPU 33 performs an image contrast search process as a focus detection process. In this focus detection process, the CPU 33 performs a process in which the CPU 33 captures images consecutively via the image sensor 15 while moving the focusing lens group L1 stepwise from the closest (shortest) focus position (near extremity) to the infinity focus position (far extremity), or vice versa, via a motor driver 41, the AF motor 43 and the lead screw 21, stores contrasts (contrast values) of the captured images in an internal RAM 33a of the CPU 33, and the CPU 33 repeats this process until the focusing lens group L1 reaches the infinity focus position or the closest (shortest) focus position. Thereafter, the CPU 33 detects a peak contrast value (peak contrast) based on the contrasts of the captured images stored in the internal RAM 33a that are captured at consecutive positions of the focusing lens group FL in the optical axis direction, and thereupon moves the focusing lens group FL to the position of the focusing lens group FL at which the peak contrast value has been obtained. The image sensor 15 and the CPU 33 constitute a focus detector that utilizes an image contrast detection method. In the present embodiment of the digital camera, the position in the optical axis direction at which the origin detection sensor 27 detects that the light shield plate 17e has passed through the origin detection sensor 27 (at which the origin detection sensor 27 is turned OFF from the ON state) when the light shield plate 17e moves toward the short distance side is defined as a focus origin position, an AF pulse counter is set to zero as a reference value, and thereafter this AF pulse counter is incremented and decremented each time the encoder 45 outputs an AF pulse when the focusing lens group FL is driven toward the short distance side and the long distance side, respectively.

The present embodiment of the digital camera is provided with a predetermined photographing mode in which the focusing lens group FL is moved to a predetermined lens position. In the present embodiment, the infinity mode constitutes the predetermined photographing mode in which the infinity focus position is designated as the predetermined lens position. The infinity mode is selected by an operation of the mode select switch SWMo. Immediately after the infinity mode is selected, the CPU 33 actuates and drives the AF motor 43 via the motor driver 41 in a rotation direction to move the focusing lens group FL toward the origin detection sensor 27, which causes the lead screw 21 to rotate in a direction to move the focusing lens group FL toward the infinity focus position. Immediately after the origin detection sensor 27 detects that the light shield plate 17e has passed through the origin detection sensor (i.e., the origin detection sensor 27 is turned ON from the OFF state), the CPU 33 actuates and drives the AF motor 43 in the reverse direction (in a rotation direction to move the focusing lens group FL toward the short distance side), and starts counting AF pulses output from the encoder 45 upon detecting that the front edge 17f of the light shield plate 17e (i.e., the focusing lens group FL) is positioned at the focus origin position by detecting a change in the ON/OFF state of the origin detection sensor 27 from ON to OFF. Thereafter, upon the counter value of the AF pulse counter reaching the infinity value N, the CPU 33 stops the AF motor 43. This process makes it possible to bring the focusing lens group FL to a halt at the infinity focus position.

With the above described process of moving the focusing lens group FL to the infinity focus position, even if the lead screw 21 elongates due to an increase in ambient temperature, the focusing lens group FL can be moved to the infinity focus position regardless of temperature variations because the origin detection sensor 27 and the infinity focus position are close to each other.

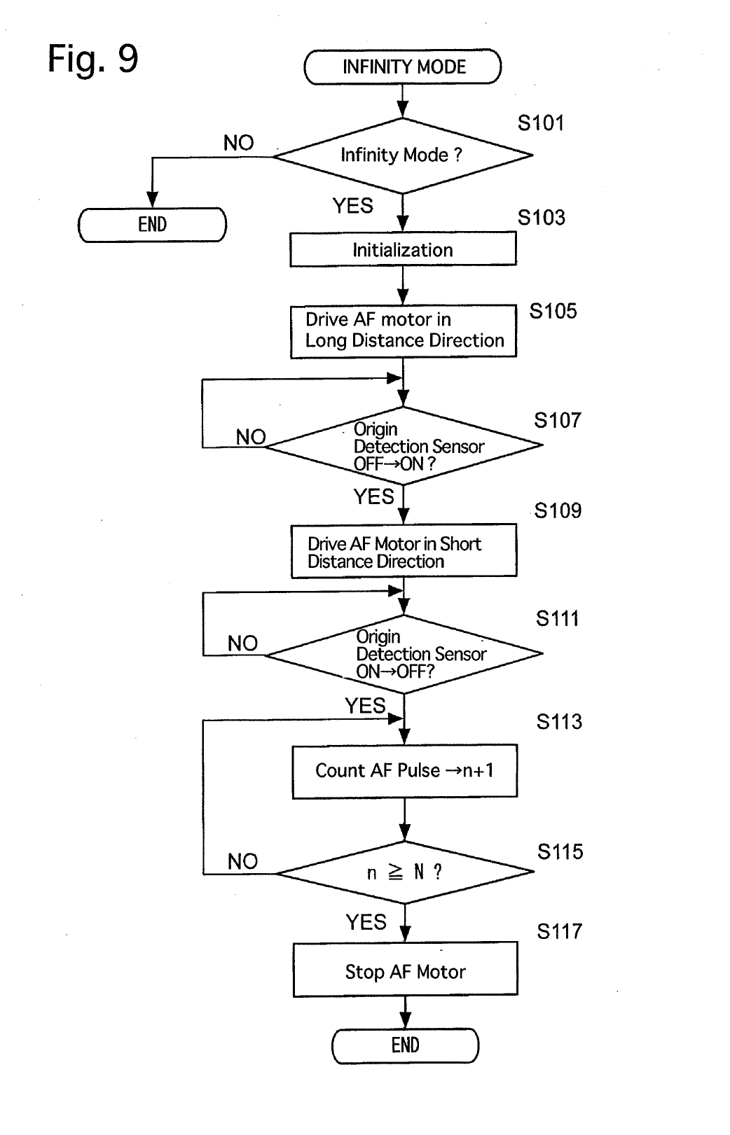

The process of moving the focus lens group FL to the infinity focus position in the infinity mode (hereinafter referred to as infinity mode process) will be hereinafter discussed with reference to the flow chart shown in FIG. 9. Control enters the infinity mode process shown in FIG. 9 immediately after infinity mode is selected by an operation of the mode select switch SWMo. In the infinity mode, the focus origin position is detected by controlling the movement of the focusing lens group frame 17 in a manner such that the light shield plate 17e passes through the gap 27b of the origin detection sensor 27, and thereafter the focusing lens group frame 17 is advanced to the infinity focus position with the focus origin position as a reference.

In infinity mode, firstly it is determined whether or not the currently-selected exposure mode is infinity mode (step S101). If the currently-selected exposure mode is not infinity mode (if NO at step S101), control ends the infinity mode process. If the currently-selected exposure mode is infinity mode (if YES at step S101), operations at steps S103 through 5117 are performed.

At step S103, variables such as the count value n are initialized. Subsequently, the AF motor 43 is driven in a direction (long distance direction) to move the focusing lens group FL toward the long distance side (step S105), and it is determined whether or not the origin detection sensor 27 has changed from the OFF state to the ON state, i.e., control waits for the ON/OFF state of the origin detection sensor 27 to change from the OFF state to the ON state (step S107 and if NO at step S107). Namely, control waits for the front edge 17f of the light shield plate 17e to pass through the focus origin position (the gap 27b) in the direction toward the long distance side from the short distance side.

Immediately after the origin detection sensor changes from the OFF state to the ON state (if YES at step S107), the AF motor 43 is driven in a reverse direction (short distance direction) to move the focusing lens group FL toward the short distance (step S109) and it is determined whether or not the origin detection sensor 27 has changed from the ON state to the OFF state, i.e., control waits for the ON/OFF state of the origin detection sensor 27 to change from the ON state to the OFF state (step S111 and if NO at step S111). Namely, control waits for the front edge 17f of the light shield plate 17e to pass through the focus origin position (the gap 27b) in the direction toward the short distance, and hence, the focusing lens group FL has been moved to the focus origin position. Upon the origin detection sensor 27 changing from the ON state to the OFF state (if YES at step S111), i.e., immediately after the front edge 17f reaches the focus origin position, the aforementioned AF pulse counter starts counting AF pulses output from the encoder 45 to increment the count value n by one (step S113). Thereafter, it is determined whether or not the count value n is equal to or greater than the infinity value N (step S115). If the count value n is not equal to or greater than the infinity value N (if NO at step S115), control returns to step S113 so that the operation at step S113, at which the count value n is incremented by one, and the operation at step S115 are repeated.

Upon the count value n (that indicates the number of AF pulses) becoming greater than or equal to the infinity value N (if YES at S115), the AF motor 43 is stopped (step S117), and control ends the infinity mode process (END). It should be noted that during this infinite mode process a focus-state detecting operation is not performed by the focus detector. In an alternatively embodiment, the focus origin position is obtained via the light shield plate 17e passing through the gap 27b of the origin detection sensor 27 upon the power being turned ON, and thereinafter only the AF pulse counting process is performed to determine the infinity focus position without the light shield plate 17e returning back to the origin detection sensor 27 in order for the focusing lens group FL to move back to the infinity focus position. Therefore, upon infinity mode being selected, the AF motor 43 is driven so that the count value n becomes equal to the infinity value N. According to this embodiment, the processing time is reduced because there is no need to move the focusing lens group FL to the focus origin position.

As described above, according to the present invention, since the focus origin position, which is detected by the origin detection sensor, and the infinity focus position are close to each other, the number of rotations of the lead screw 21 required to move the focusing lens group FL from the focus origin position to the infinity focus position is small. Therefore, when infinity mode is selected, even if the driving of the focusing lens group FL is controlled so that the focusing lens group FL moves to the infinity focus position by the number of AF pulses (the infinity value N) measured in advance from the focus origin position detected by the origin detection sensor 27, the influence of the thermal expansion/contraction of the lead screw 21 that is used to drive the focusing lens group FL can be small.

Additionally, in the present embodiment of the digital camera, since the lead screw 21 and the spur gear 21d are formed integrally with each other, the number of elements is reduced; moreover, the lead-threaded portion 21a can be made long relative to the length of the lead screw 21.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A focusing apparatus including a lead screw made of resin, both ends of which are supported by at least one stationary member to be freely rotatable, and a focusing lens group that is movable in an optical axis direction by rotation of said lead screw, said focusing apparatus comprising:
a position detection sensor for detecting whether said focusing lens group is positioned at a reference position in said optical axis direction; and
a focus detector which performs a focus-state detecting operation to detect a focus state of an object,
wherein said focusing apparatus moves said focusing lens group to a predetermined lens position in which said focus-state detecting operation is not performed, and
wherein said reference position is positioned in a close vicinity of said predetermined lens position.

2. The focusing apparatus according to claim 1, wherein said focusing apparatus is incorporated in a digital camera, and
wherein said focus detector comprises an image sensor and detects said focus state of said object by detecting contrasts of object images which are captured via said image sensor while said focusing apparatus moves said focusing lens group stepwise by rotating said lead screw stepwise.

3. The focusing apparatus according to claim 1, further comprising a memory which stores a rotation amount of said lead screw as a set value required to move said focusing lens group to said predetermined lens position from a moment said point detection sensor detects that said focusing lens group is positioned at said reference position.

4. The focusing apparatus according to claim 3, further comprising:
a driver which rotates said lead screw;
a measuring apparatus which measures a rotation amount of said lead screw from a moment said position detection sensor detects that said focusing lens group is positioned at said reference position; and
a controller which controls rotation of said lead screw via said driver based on said set value that is stored in said memory and said rotation amount that is measured by said measuring apparatus when said controller moves the focusing lens group to said predetermined lens position.

5. The focusing apparatus according to claim 4, wherein said measuring apparatus continues to measure a position of said focusing lens group in said optical axis direction as said rotation amount of said lead screw from when said position detection sensor detects that said focusing lens group is positioned at said reference position, and
wherein, when said focusing apparatus moves said focusing lens group to said predetermined lens position, said controller controls said driver so that a measurement value measured by said measuring apparatus becomes equal to said set value stored in said memory.

6. The focusing apparatus according to claim 4, wherein, when moving said focusing lens group to said predetermined lens position, said controller drives said driver in a direction to allow said position detection sensor to detect said focusing lens group when said focusing lens group is positioned at said reference position,
wherein said controller actuates said driver in a direction to move said focusing lens group to said predetermined lens position and makes said measuring apparatus commence measuring said rotation amount of said lead screw from a moment said point detection sensor detects that said focusing lens group is positioned at said reference position, and
wherein said controller stops driving said driver upon a measurement value measured by said measuring apparatus becoming equal to said set value that is stored in said memory.

7. The focusing apparatus according to claim 1, wherein said predetermined lens position corresponds to an infinity focus position.

8. The focusing apparatus according to claim 1, wherein said focusing lens group is continuously biased toward a short distance side by a resilient member, and
wherein said predetermined lens position and said position detection sensor are positioned in a close vicinity of a rear limit of a moving range of said focusing lens group which is determined by said lead screw.

9. The focusing apparatus according to claim 1, wherein a gear is formed integrally with said lead screw, and
wherein said lead screw is rotated by a motor.

10. The focusing apparatus according to claim 9, wherein said measuring apparatus measures a number of rotations of said lead screw as a number of rotations of said motor or a number of rotations of said gear.

11. The focusing apparatus according to claim 1, wherein said position detection sensor comprises a photo interrupter.
